(19) United States
(12) Patent Application Publication
(10) Pub. No.: US 2005/0260320 A1
(43) Pub. Date: Nov. 24, 2005

(54) Multicolored flow divider

(76) Inventor: Christopher S. Hannaford, Golden Valley, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 11/136,226

(22) Filed: May 24, 2005

Related U.S. Application Data
(63) Continuation-in-part of application No. 10/682,461, filed on Oct. 9, 2003, now abandoned.
(60) Provisional application No. 60/573,932, filed on May 24, 2004.

(51) Int. Cl. A21D 10/00

(52) U.S. Cl. 426/549

(57) ABSTRACT

A pressurized dough processing system for producing a plurality of discrete dough product streams, and attendant process, is provided. The system includes a pressurized dough manifold or network, and at least a single admix station for introducing a dough additive to at least a single pressurized dough stream from the dough manifold so as to define at least two or more discrete dough streams. At least a single positive displacement flow divider, advantageously comprising a plurality of positive displacement cells, is provided for processing at least one discrete dough stream of the at least two or more discrete dough streams.

This is a regular application filed under 35 U.S.C. §111(a), more particularly, a continuation-in-part of co-pending application Ser. No. 10/682,461 filed Oct. 9, 2003, claiming priority under 35 U.S.C. §119(e)(1), of provisional application Ser. No. 60/573,932 having a filing date of May 24, 2004.

### TECHNICAL FIELD

The present invention relates to the extrusion, dispensing, and/or processing of viscous foodstuffs, e.g., dough or dough-like material, and, more particularly, to processes and attendant systems for facilitating the production of a combined dough product comprising at least two discrete dough constituents, as for example, a multi-colored confection rope or twist.

### BACKGROUND OF THE INVENTION

Doughs and dough-like materials are found in many arts. In the food industry, for example, doughs are used for bread and many candy products. Such doughs are typically sticky and are not truly a fluid in that they do not take the shape of a container in to which they are put. That is, a ball of dough mostly retains the shape of a ball.

In the food industry, and most particularly in the candy industry, it is often desired to produce shaped ropes, as by extruding. Because of the high viscosity, e.g., 4,000,000-8,000,000 centipoise being common for licorice, extrusion of such material may require the delivery of the dough at up to several hundred pounds per square inch (psi) of pressure. For many applications, it is also desirable, or necessary, to provide a mechanism which removes air bubbles from the dough.

One prior art system employs a single-screw, open-flighted extruder having an open hopper. The dough (licorice is common) is cooked continuously and dropped at atmospheric pressure into the hopper. Such extruders are limited to approximately 100 psi which limits their capabilities.

Another prior art system which is capable of generating more than 100 psi to improve extruding capabilities employs a twin-screw extruder and cooks the dough inside the extruder. By manufacturing the dough within the extruder, the problem of feeding the viscous, sticky dough is moot.

As noted above, the first mentioned prior art approach produces a pressure too low for many applications. The second described system provides sufficient pressure but is too costly for many applications. Also, in spite of the high cost, cooking the dough inside the extruder often produces an inferior dough.

Beyond issues of extrusion per se, attendant issues of distributing and/or metering viscous food, and non-food material are also well documented. For instance, related U.S. Pat. Nos. 5,536,517, 5,688,540, and 5,840,346 (Hannaford), each of which are incorporated herein by reference, detail the challenges associated with the delivery of equal amounts of temperature/pressure sensitive material from a number of dies, and provide for positive displacement, synchronized metering, i.e., flow dividing, of pressurized extrudate to a plurality of dies.

In addition to delivering a food dough to a die efficiently and at sufficient pressure, it is often desired to intermix or admix minor or secondary constituents such as colorants and/or flavorings, or more generally, dough additives. Static mixers are well known for this purpose and are used in a twin-screw extruder system disclosed in Christensen et al. U.S. Pat. No. 5,776,534 issued Jul. 7, 1998. The twin-screw, with its issues as described above, has output characteristics which allow utilization of prior art static mixers. See also Meisner U.S. Pat. No. 4,925,380 issued May 15, 1990 for the use of static mixers in a system wherein a product flow is split for separate coloring via static mixers.

In the context of the previously noted positive displacement, synchronized metering or flow dividing, metering means thereof are well suited to provide a secondary functionality, namely, that of mixing. For instance, each gear pair of the metering means meters the material as the meshing gears shear material caught in the teeth to provide an effective mixing action. This mixing action can be advantageously utilized, as by introducing an extrudable or even a pumpable supplemental material, i.e., an additive, under a pressure substantially equivalent to that of the pressurized food material, into a gear pair input where the gear pair will mix it with the food material. Extrudable supplemental materials or additives can include such things as a liquid, a viscous solid, or a combination thereof. These examples are given as illustrations, without limitation, any material which can be pumped or extruded can be used as a supplemental material.

As is well known, supplemental material can itself be, or can contain a coloring agent, a flavoring agent, or any other agent or combination thereof which will modify a characteristic of the food material. Injected supplemental material which is a liquid will be mixed well with the food material by the action of the gear pair itself, no additional equipment being required. For extrudable material, static mixers have heretofore been placed in the material stream between the metering device and the die. This permits efficient and advantageous processing, such as extruding streams of food from different dies having different colors or flavors while using only one food material.

Finally, it is further well known that one or more supplemental materials can themselves be displacement metered. When gears are used for metering, the gears of the supplemental material gear pair can be attached to the same shafts as the other gear pairs with its output flowing into the input of the gear pair metering the food material. Since this is a supplemental material, a smaller volumetric flow is required than that of the food material, however, volumetric displacements of gear pairs can be selectively incorporated to achieve the sought after advantage.

Although advances have been made, it nonetheless remains advantageous to improve known devices, systems, and processes relating to the extrusion, dispensing, and/or processing of viscous foodstuffs. More particularly, it is desirable to eliminate elements while retaining functionality in such processes or systems, and further, to reassess unit operation functionality in furtherance of providing advantageous processing flexibility. For example, it is believed advantageous to provide a process for making a multiply-colored (or, textured, or flavored, etc.) dough product from a single source of pressurized dough, especially in the context of feeding coextrusion dies and the like, wherein a positive displacement flow divider is supplied down stream from an admix operation.

### BRIEF DESCRIPTION OF THE PRESENT INVENTION

The present invention preferably but not necessarily employs a progressing cavity pump which is capable of efficiently delivering high viscosity doughs and dough-like materials at the pressures necessary for effective extrusion with little shear damage. Progressing cavity pumps are known, having been patented in 1932 by Rene Joseph Moineau as shown and described in U.S. Pat. No. 1,892,217.

As is well known, progressing cavity pumps work well for products that can flow into their inlet hopper—those that are fluid (as opposed to dough-like) as represented generally by their viscosity. Such pumps are commonly used in the sewage industry for pumping slurries.

Food doughs, including candy dough, do not flow well, if at all. Also, it is important to not bring air bubbles with the product into the pump. For one, or both, of these reasons, or other reasons, progressing cavity pumps have not been employed for food doughs. That is, the inability of the dough to “flow” into the pump, and/or the air induced or carried with the dough into the pump by force feeding, have restricted the use of progressing cavity pumps in the food dough industry.

The present dough delivery system of the subject invention preferably, but not necessarily combines a roll feeder of known design with a progressing-cavity pump to provide a device which is suitable for extruding food doughs and, particularly, candy dough. Use of a screw feeder intermediate the feeder and progressing cavity pump is desirable.

The roll feeder consists of two counter-rotating rollers with a gap between them and two scrapers that remove product from the rollers on the discharge side. The roll feeder forces dough into the progressing cavity pump inlet or into the screw that feeds the progressing cavity pumps, if used. In addition, the roll feeder removes air from the dough and is capable of mixing any minor liquid ingredients such as flavorings and/or colorings which may be dripped onto the rolls or the dough in the hopper, for example.

In a preferred embodiment, the present invention provides an extruder for food dough. In its basic form, the outlet of the progressing cavity pump may be shaped, and as such, the pump functions as an extruder for food dough. Alternatively, the pump output may be separated into separate streams, as by a manifold or the like, with minor constituents or additives being differentially added to each stream so as to provide streams of different colors, flavors, etc. Those streams may then be co-extruded, if desired.

The capability of the pump overcomes pressure drop in the piping and allows efficient mixing of the minor constituents, as by static or other mixers, without the need for expensive twin screw arrangements. Also the ability to add minor constituents downstream from the pump allows a fast changeover from one constituent to another, as will be obvious to those familiar with the art. Additionally, the fact that a progressing cavity pump is a positive displacement device allows cleaning of the system by circulation of water or other cleaning liquid.

With regard to processes and/or systems for the extrusion, dispensing, and/or processing of viscous foodstuffs, e.g., dough or dough-like material, a pressurized dough processing system for producing a plurality of discrete dough product streams, and attendant process, is provided. The system includes a pressurized dough manifold or network, and at least a single admix station for introducing a dough additive to at least a single pressurized dough stream from the dough manifold so as to define at least two or more discrete dough streams. At least a single positive displacement flow divider is provided for processing at least one discrete dough stream of the at least two or more discrete dough streams. Such process permits, and greatly facilitates the production of a combined dough product comprising at least two discrete dough constituents, as for example, a multi-colored confection rope or twist.

A critical feature of the process/system of the subject invention requires placement of one or more positive displacement flow dividers after an admix station, i.e., the flow divider is to be fed a discrete dough product, namely, a stream of dough from the single source of pressurized dough characterized by the additive. By this arrangement, the one or more flow dividers control the rate of flow of discrete dough product through a mixer or the like up stream in the admix operation, as well as determining the flow rate flowing out of the flow divider. The rate of flow of dough product through each mixer is proportional to the rate of rotation of the positive displacement flow divider. Effectively the flow dividers do a double-flow-dividing, both controlling the rate of flow to each individual stream and the flow of each dough product to its flow divider.

### BRIEF DESCRIPTION OF THE DRAWINGS

FIG. 1 is a schematic representation of an extruder assembly in accordance with the present invention;

FIG. 2 is a schematic representation illustrating the operation of a roll feeder in accordance with the present invention;

FIG. 3 illustrates an alternative embodiment of a portion of the roll feeder illustrated in FIG. 2;

FIG. 4 illustrates a multi-stream co-extrusion arrangement in accordance with a process and/or system of the present invention;

FIG. 5 illustrates a process and system of the subject invention wherein powered flow dividers process discrete dough streams, a source of pressurized dough being subordinate to the powered flow dividers;

FIG. 6 illustrates the process/system of FIG. 5 wherein the powered flow dividers are subordinate to the source of pressurized dough;

FIG. 7 illustrates the process/system of FIG. 5 wherein the flow dividers are passively powered, more particularly, wherein the dividers are driven indirectly by the source of pressurized dough and are thus responsive thereto;

FIG. 8 illustrates a process similar to that of FIG. 5, discrete dough streams being fed to a single powered flow divider;

FIG. 9 illustrates a process similar to that of FIG. 6, discrete dough streams being fed to a single powered flow divider;

FIG. 10 illustrates a process similar to that of FIG. 7, discrete dough streams being fed to a single powered flow divider; and,

FIG. 11 illustrates parallel operation of the process of FIG. 8 wherein divided flow is discharged to a co-extrusion die.

### DETAILED DESCRIPTION OF THE DRAWINGS

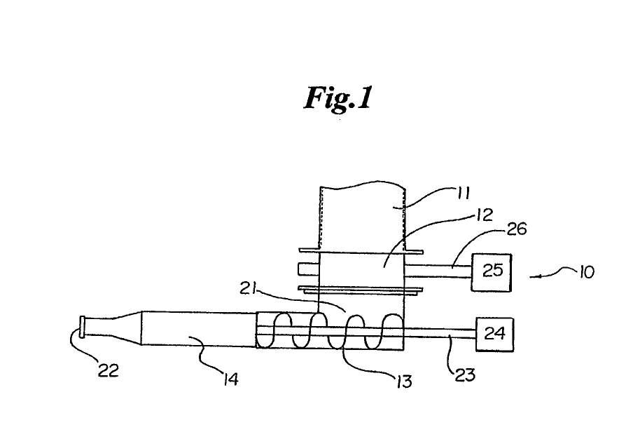

FIG. 1 illustrates an extruder assembly in accordance with the present invention including a hopper 11, a roll feeder 12, a screw feeder 13, progressing cavity pump 14 and extruding outlet 22. Progressing cavity pumps are known and are commercially available. In such pumps, a spiral, metal “rotor” rotates inside a tube which has a doubled-spiral stator cavity. A motor rotates the rotor which wobbles as it rotates in the stator, in known manner, to provide a positive displacement pumping action. For this application as an extruder, the progressing cavity pump should have a solid metal rotor and stator for higher pressure operation. Otherwise, the pump may be as described in U.S. Pat. No. 1,892,217 which is hereby incorporated by reference.

The screw feeder 13 is also known in the art in combination with progressing cavity pumps. Indeed, they may be bought in combination as a single unit such as that sold by Moyno Industrial Products under Model No. 1FGJ3SJG and other manufacturers. While it has been found desirable for a screw feeder 13 to be employed at the inlet 14 to deliver dough to the extruder, the screw feeder may not be required for all applications.

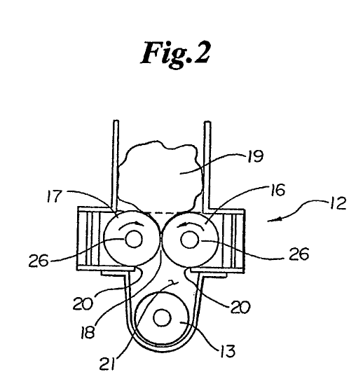

Dough to be extruded is delivered to the hopper 11 which serves to contain the dough and assists in maintaining it in position relative to the roll feeder 12. The cooperation of the hopper and roll feeder are illustrated in FIG. 2 wherein two (2) counter-rotating rollers 16 and 17 rotate in the direction of the arrows. The rollers 16 and 17 are located side by side having a gap or nip 18 of approximately ¼ inch between them. Rotation of the rollers forces the dough 19 through the nip 18 in a downward direction toward the screw 13. Scrapers 20 are provided to scrape most of the dough 19 from the rollers 16 and 17 leaving a layer of dough on the rolls approximately ⅛ thick. This dough coating on the rollers 16 and 17 facilitates the feeding of the roll feeder 12 while the scrapers 20 remove most of the dough. The action of the rollers 16 and 17 and scrappers 20 create a slightly pressurized area 21 at the inlet of the screw feeder 13. In the event that excess dough (dough that is not removed by the extruder assembly) is delivered to the chamber 21 by the roll feeder 12, it is forced backward through the nip 18 of the rolls 16 and 17 and into the ball of dough 19. The action of the rollers 16 and 17 at the nip 18 serves to de-air the dough as it passes through them rendering that dough particularly suitable for candy extrusion, for example.

As described, the present invention provides an extruder assembly for dough-like material employing a progressing cavity pump having an inlet and an outlet. A roll feeder is employed to deliver the dough-like material, under pressure, to the extruder assembly. The extruder assembly may include a screw feeder, as illustrated. In some instances the screw feeder may not be necessary. However, the feeder assembly is considered desirable for most applications. In any case, the use of a progressing cavity pump allows the extrusion of viscous dough-like material at high pressures. The outlet 22 of the assembly may be shaped to form the dough into a desired shape. That is, the outlet 22 may be a “die”. Alternately, outlet 22 represents other extruder configurations, as described below. As illustrated, shaft 23 drives both the screw 13 and pump 14, in known manner, the shaft 23 being powered by a motor 24. Similarly, a motor 25 drives shafts 26 of the rollers 16 and 17, the rollers 16 and 17 rotating with the shafts 26.

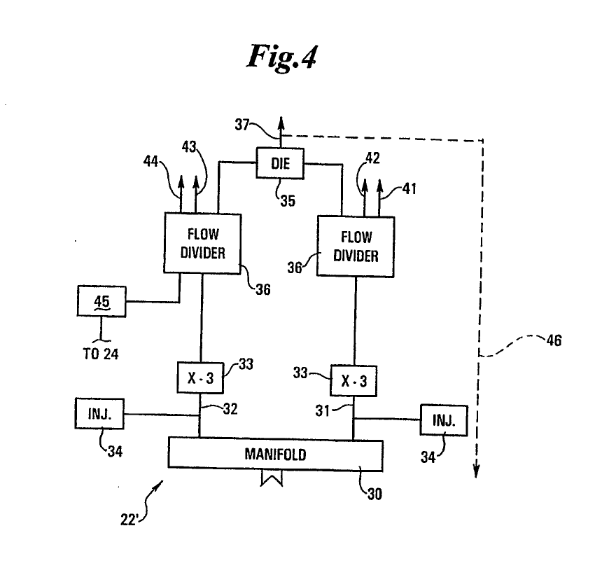

In the discussion above, outlet 22 is stated as representing an extruder. An extruder 22′ is illustrated in FIG. 4 including a manifold 30 which receives the output of the pump 14. Two output streams exit the manifold 30 via lines 31 and 32 to pass into mixers 33. The mixers 33 may be static mixers of type known in the art or other type of mixer, powered mixers, for exmample. Injectors 34 for minor constituents such as flavorings or colorants may deliver their output to the lines 31 and 32, the injectors 34 consisting generally of reservoirs for the desired constituents and pumps for delivering the desired amount of constituent to the lines 31 and 32, in known manner. It is within the skill of one familiar with the art to regulate the amount constituent based upon the flow in the lines 31 and 32.

After thoroughly mixing the minor constituents, the streams may be separately extruded, in known manner. However, an advantage of the present invention is the ability to provide separate, independent streams for the selective addition of minor constituents and then utilize those streams for co-extrusion. Thus, the streams flowing from the mixers 33 may be co-extruded as at a co-extrusion die 35. Given the capacity of an extruder in accordance with the present invention (resulting from the utilization of a progressing cavity pump), it is within the scope of the present invention to further divide the streams from the mixers 33 as by flow dividers 36, with one stream from each of the flow dividers 36 passing to the co-extrusion die 35 to result in a co-extruded product as represented at 37. The flow dividers may be those disclosed in Hannaford U.S. Pat. No. 5,536,517 issued Jul. 16, 1996. The flow dividers 36 illustrated in FIG. 4 have three outputs with the outputs 41, 42, 43, and 44 being directed to dies or co-extrusion dies, as desired. A pressure sensor 45 may be employed in a feedback pressure control loop so as to regulate the motor 24 of FIG. 1 to maintain the pressure of manifold 30 constant, in known manner. Pressure relief or control may also be provided, as by a valve, surge tank or recirculation back to the input, as is well known in the art.

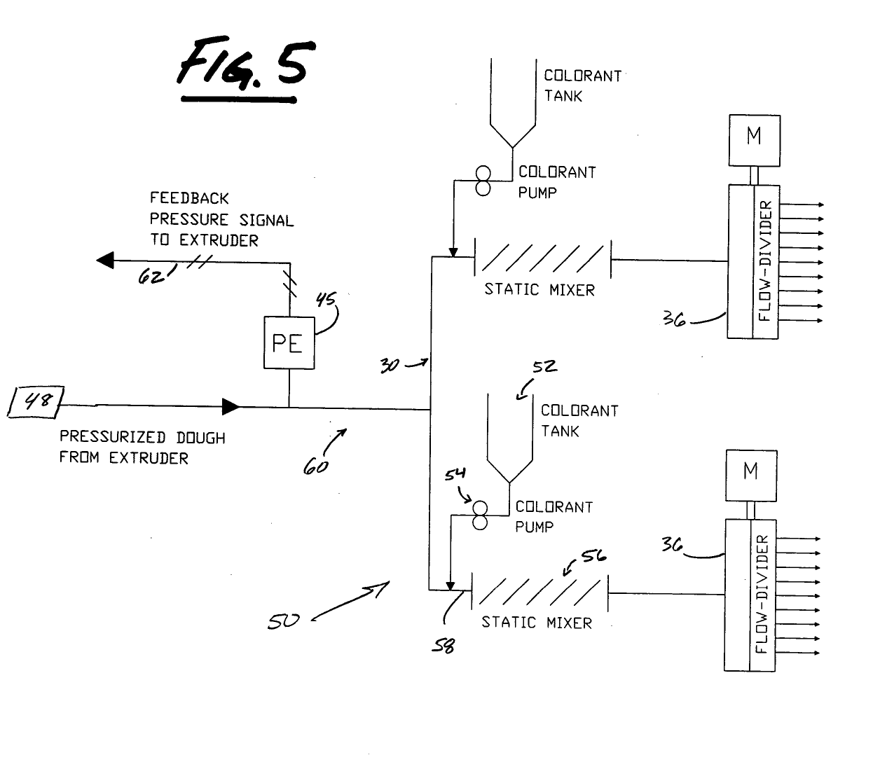

With reference now to the processes and systems of FIGS. 5-11, and building from the process of FIG. 4, all advantageously include a positive displacement flow divider 36 down stream of an admix operation 50 comprising an additive source 52, e.g., a tank, an additive injector 54, e.g., a pump, and a mixing element 56, e.g., a static or powered mixer. The subject configuration permits or enables the flow dividers to control the rate of flow of discrete dough product 58 through each mixer 56, as well as determining the flow rate flowing from or being discharged from the flow divider 36. As the flow into the flow divider is equal to the sum of the flow streams exiting the flow divider, and the rate of flow of discrete dough product through each mixer is proportional to the rate of rotation of the positive displacement flow divider in that process sub-unit, the flow dividers effectively do a double flow dividing, both controlling the rate of flow to each individual stream, and the flow of each additive to its flow divider.

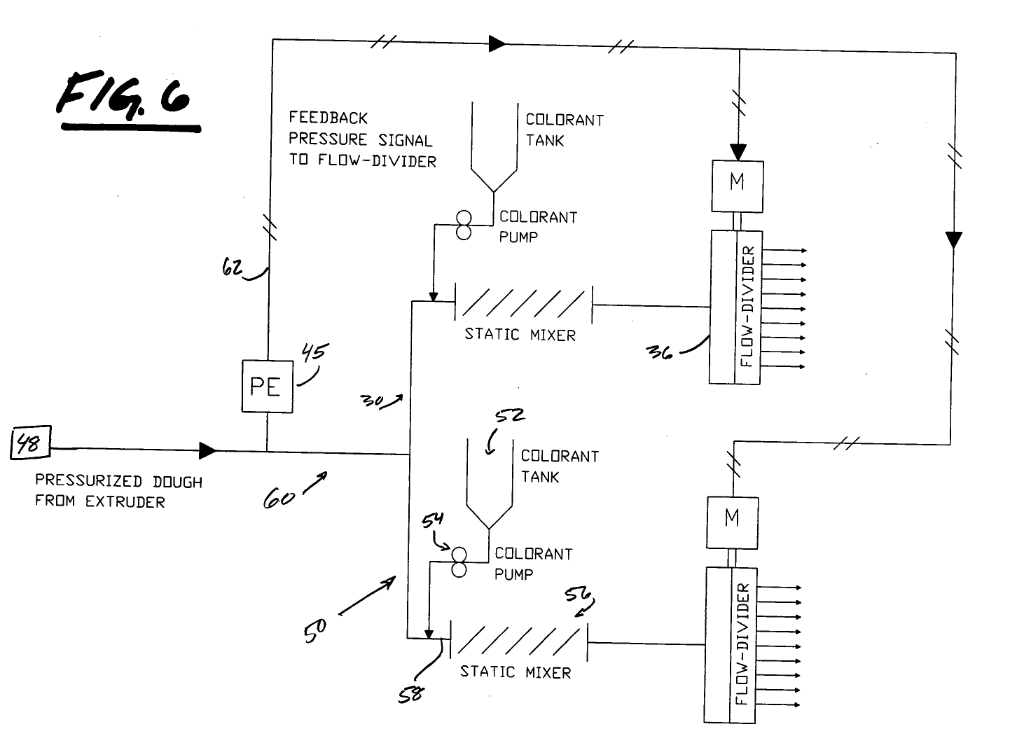

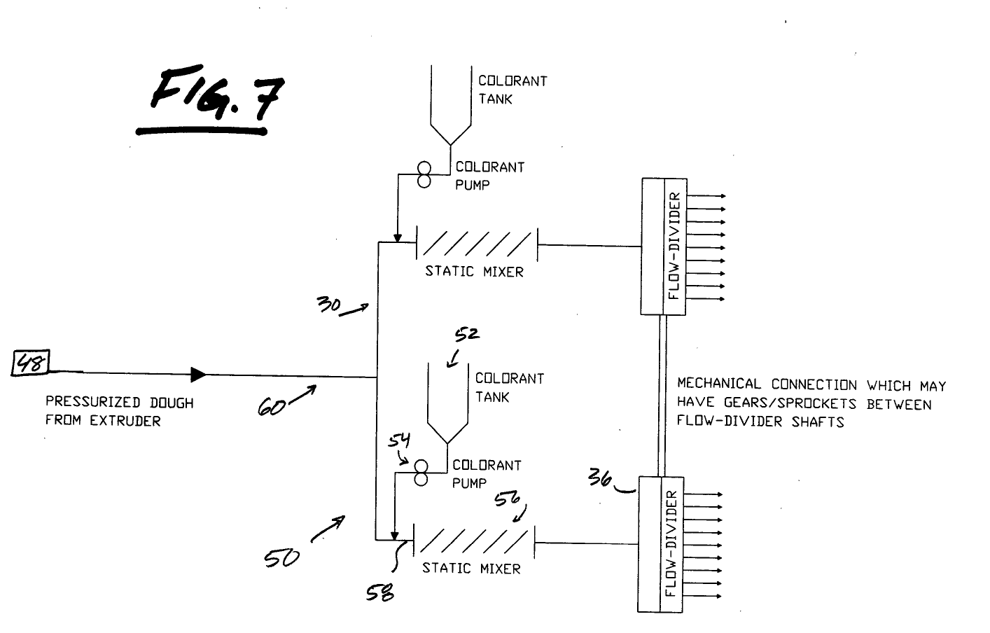

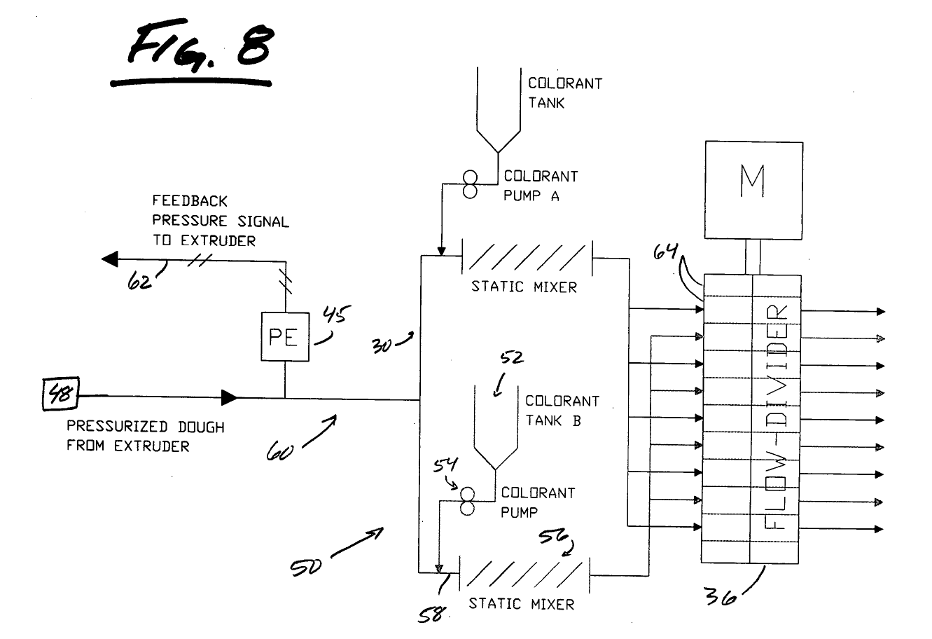

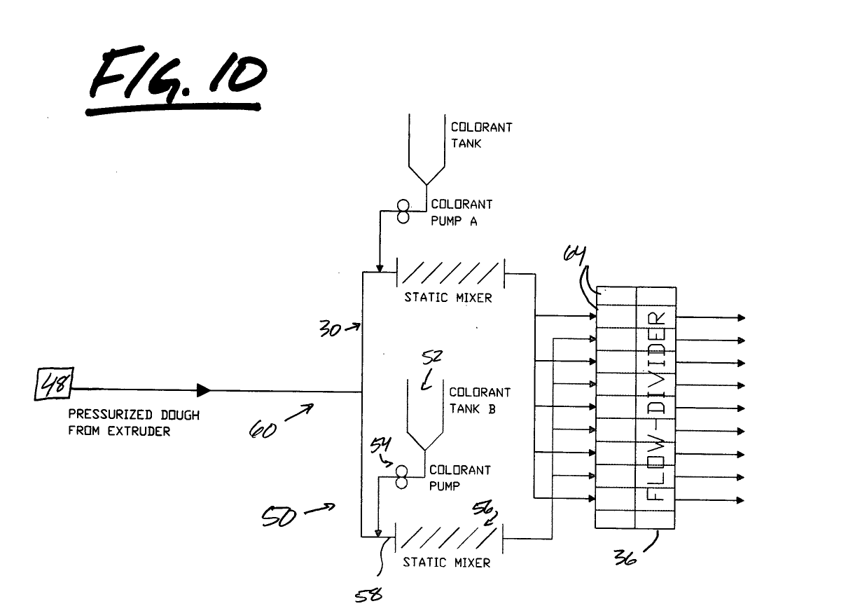

In the processes illustrated, it is contemplated that: actively powered flow dividers (FIGS. 5, 6, 8, and 11), and passive flow dividers (FIGS. 7 and 10) be utilized; the flow divider(s) be “master” to a subordinate source of pressurized dough (FIGS. 5, 8, and 11), or “slave” to a superior regulating source of pressurized dough (FIGS. 6, 7, 9 and 10); and, that each discrete dough stream have a dedicated flow divider (FIGS. 5-7), or that each flow divider is to process greater than one discrete dough stream (FIGS. 8-11). It is to be understood that the disclosed processes and/or systems are intended to be illustrative, and in no sense intended to limiting, the claims herewith, and their equivalents, defining the scope of the subject invention(s).

With reference to FIG. 5, preferably, a source of pressurized dough 48, e.g., an extruder/pump, delivers dough under essentially constant pressure to the distribution system 60, e.g., a network comprising a manifold 30, with the flow divider shaft turned at a preselect rate so as to deliver a minimally required amount of product, typically at a constant speed so as to yield a constant flow. In this configuration, the flow divider is master and the extruder rate is effectively slaved to provide or deliver a rate of dough flow at a preselect pressure. As shown, a pressure sensing element 45 of a motor controller, not shown, is provided so as to monitor the supply or source of pressurized dough product 48. To the extent static mixers are used to mix in minor ingredients/additives up stream of the powered flow dividers, the pressure supplied by the extruder, or the like, must be sufficient to overcome the pressure drop caused by the product flowing through the static mixers. Finally, it is to be noted that the flow divider could have one or more positive displacement cells, i.e., produce one or more streams of dough of each color/additive, see e.g., FIG. 8.

Referring now to FIG. 6, it is further contemplated that the pressurized dough be delivered at a predetermined flow rate, typically at a constant flow rate, and the flow dividers 36 be turned at such a rate so as to “balance” the flow, i.e., remove the same rate of flow of dough as delivered. In this arrangement, and as shown, a feedback signal to the flow dividers 36 can be provided by an electric signal 62 from the pressure sensor 45 to the motor controllers to alter the rotation rate of the flow divider shafts so as to maintain a constant pressure at the extruder discharge.

Referring now to FIG. 7, a simplified FIG. 6 process/system is shown, namely, one wherein pressure powered flow dividers 36 are substituted for the motor driven variety. In such flow metering devices, the pressure of the dough causes the flow divider to freewheel so that motors are not needed to turn the shafts. A mechanical linkage connects the shafts of multiple flow dividers so that they turn together, for example connected by gears or chain and sprockets. Such freewheeling passive flow dividers automatically act as a slave to the source of pressurized dough, e.g., extruder: as more dough is delivered, it “pushes” the gears or vanes, etc. of the positive displacement flow divider to make it turn proportionally.

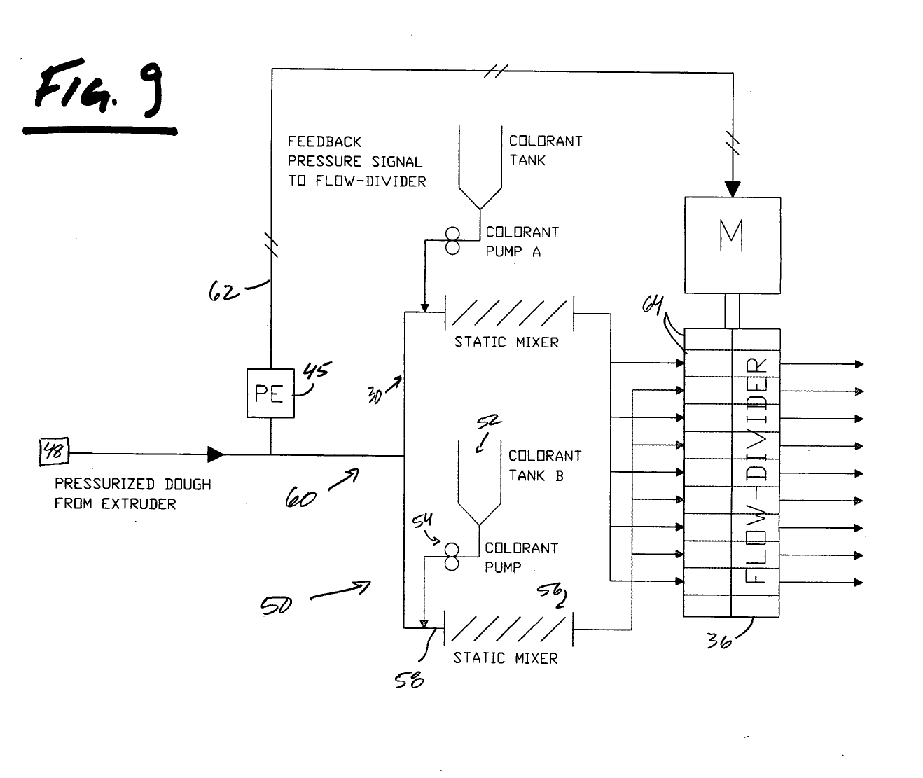

Referring now to FIG. 8, the same effect of multiple colors from uncolored dough from a single source can be achieved with a single positive displacement flow divider 36. The flow divider 36 has different colors of dough flowing through different cells 64. The cells 64 are typically connected by a common shaft and therefore the rates of dough flow through each cell of the cells 64 is proportional to the rate of revolution of the shaft. As shown, two different dough “colors” (i.e., discrete dough streams) are run through adjacent cells of a single flow divider. As should be readily appreciated, a small amount of hardware that is physically small and relatively cheap can produce multiple streams of multiply-colored dough. As previously noted, the instant process may likewise instead include a slaved flow divider arrangement, either comprising a powered flow divider (FIG. 9), or a passive unit (FIG. 10).

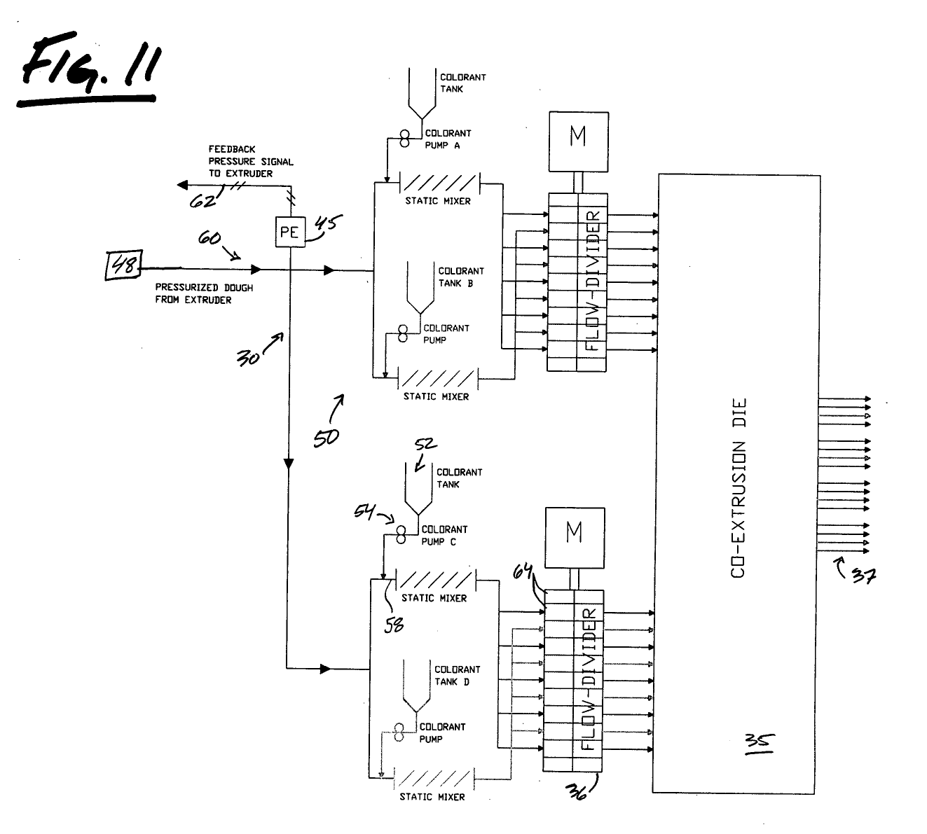

Finally, referring now to FIG. 11, there is shown parallel operation of the flow dividing as depicted in FIG. 8, namely, parallel powered flow dividers 36, each of which is being fed greater than one discrete dough stream, namely streams 58a-d. This arrangement is especially advantageous as more different colors of dough can be produced in the same linear length of flow divider, i.e., many discrete dough streams can be produced in a very small linear length across a flow divider or extrusion head. This is important, for example in trying to produce multiple ropes of a coextruded multi-color candy product to be laid across a conveyor belt. The ropes have to be close together for the ease of the following equipment such as cooling tunnels, cutters and packaging equipment.

As previously described, the output from the extruder in FIG. 1 may be employed for a single stream extrusion, a multiple stream extrusion or single or multiple stream co-extrusions, as desired. In any case, static mixers such as those illustrated at 33 in FIG. 4, may be employed to thoroughly intermix the desired minor constituents as provided by the injectors 34, in known manner. Thus, in accordance with the present invention, a dough-like material such as food dough may be advantageously extruded without the shear introduced in the prior art's high pressure systems, and without their expense. Additionally, progressing cavity pumps are positive displacement pumps which provide other advantages.

Among the chief advantages of the positive displacement characteristics of the progressing cavity pump is the fact that its output is dependent upon the rotation of its drive shaft. That is, the drive rotation rate determines the rate at which product is extruded. Additionally, the positive displacement characteristics facilitates cleaning of the system. This is illustrated in FIG. 4 by the dashed line 46 which represents a recirculation flow back to the input of the pump 14 and/or screw feeder 13 of FIG. 1. While recirculation is not required, an excessive amount of cleaning fluid (such as water) would be otherwise circulated through the system for cleaning purposes. Indeed, a progressing cavity pump mostly self cleans when the supply of new product is stopped and the pump continues running for a short period. Not only does this facilitate cleaning it also facilitates a production changeover such as a change in the input material and/or its constituent. Of course, when minor constituents are injected or otherwise inserted downstream of the pump outlet, as described above with reference to FIG. 4, cleaning activities and/or product changeover are further facilitated.

In addition to ease of cleaning and control, the extrusion pressures produced by a progressing cavity pump allow a smaller diameter extruded ropes. Significantly, the pressure provided by such pumps is also sufficient to overcome the pressure drop of known static mixers when intermixing minor constituents. There is also a size advantage over prior art systems having similar capabilities.

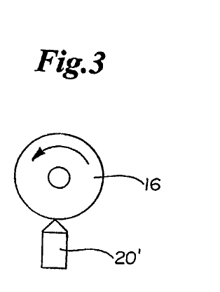

Obviously, many modifications and variations of the present invention are possible in light of the above teachings. For example, scrapers 20 illustrated in FIG. 2 are plate-like structures projecting into the area beneath the rollers 16. Alternatively, blade-like members 20′ (see FIG. 3) may be employed as scrapers for both rollers 16 and 17 (only rollers 16 being illustrated in FIG. 3). The various extrusion/co-extrusion alternatives are set out above. Blades or other devices may be used in conjunction with any of these alternatives to utilize the extruder as, or in, a depositer (an apparatus in which a viscous product is portioned, shaped and dispensed) . It is therefore to be understood that, within the scope of the appended claims, the invention may be practiced otherwise than as specifically described.

1. A process of making, from a single source of pressurized dough, a combined dough product comprising at least two discrete constituents, said process comprising the steps of:
a. dividing a flow of pressurized dough from a single source of pressurized dough into at least two process streams;
b. supplying a dough additive to at least one of said at least two process streams so as to define at least a single discrete dough product; and,
c. subsequent to said supplying, delivering said at least a single discrete dough product to at least a single positive displacement flow divider.

2. The process of claim 1 wherein said flow of pressurized dough from a single source of pressurized dough is selectively preselected.

3. The process of claim 2 wherein said flow of pressurized dough from a single source of pressurized dough includes a pressure control for regulating means for delivering said flow of pressurized dough.

4. The process of claim 2 wherein said at least a single positive displacement flow divider is actively driven so as to contribute to maintenance of a substantially constant pressure for said flow of pressurized dough from a single source of pressurized dough.

5. The process of claim 4 wherein said flow of pressurized dough from a single source of pressurized dough includes a pressure control for regulating means for processing said flow of pressurized dough through said at least a single positive displacement flow divider.

6. The process of claim 2 wherein said at least a single positive displacement flow divider is passively driven so as to contribute to maintenance of a substantially constant pressure for said flow of pressurized dough from a single source of pressurized dough.

7. The process of claim 6 wherein delivery of at least a single discrete dough product is to at least two positive displacement flow dividers.

8. The process of claim 7 wherein said at least two positive displacement flow dividers are mechanical linked for synchronous operation.

9. The process of claim 2 wherein said at least a single positive displacement flow divider comprises greater than one positive displacement cell.

10. The process of claim 9 wherein select cells of said greater than one positive displacement cell of said at least a single positive displacement flow divider receive a unique dough product from said at least a single discrete dough product.

11. The process of claim 9 wherein said at least a single positive displacement flow divider feeds a co-extrusion die.

12. The process of claim 2 wherein a plurality of discrete dough additives are supplied to a plurality of said at least two process streams so as to define a plurality of discrete dough products.

13. The process of claim 12 wherein each discrete dough product of said plurality of discrete dough products are delivered to a positive displacement flow divider.

14. The process of claim 12 wherein at least one of said at least a single positive displacement flow divider comprises greater than one positive displacement cell.

15. The process of claim 14 wherein greater than one discrete dough product of said plurality of discrete dough products are delivered to said at least one of said at least a single positive displacement flow divider comprising greater than one positive displacement cell.

16. The process of claim 14 wherein select cells of said greater than one positive displacement cell of said at least a single positive displacement flow divider receive a unique dough product from said at least a single discrete dough product.

17. The process of claim 14 wherein greater than one discrete dough product of said plurality of discrete dough products are delivered to a positive displacement flow divider.

18. A pressurized dough processing system for producing a plurality of discrete dough product streams, said system comprising a pressurized dough manifold, at least a single admix station for introducing a dough additive to at least a single pressurized dough stream from said dough manifold so as to define at least two discrete dough streams, and at least a single positive displacement flow divider for processing at least one discrete dough stream of said at least two discrete dough streams.

19. The processing system of claim 18 wherein an admix station of said at least a single admix station comprises a source of said dough additive.

20. The processing system of claim 19 wherein said admix station further comprises means for integrating said dough additive with said at least a single pressurized dough stream.

21. The processing system of claim 20 further comprising one or more co-extrusion dies for processing a plurality of discrete dough streams from said at least a single positive displacement flow divider.

22. The processing system of claim 21 wherein at least one of said at least a single positive displacement flow divider comprises multiple positive displacement cells.

23. The process of claim 22 wherein select cells of said multiple positive displacement cells of said at least one of said at least a single positive displacement flow divider receive a unique dough product from said at least two discrete dough streams.
